(19) United States
(12) Patent Application Publication
(10) Pub. No.: US 2008/0165627 A1
(43) Pub. Date: Jul. 10, 2008

(54) Time Adjustment Device, Timepiece with a Time Adjustment Device, and Time Adjustment Method

(75) Inventor: Osamu Urano, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 11/955,923

(22) Filed: Dec. 13, 2007

(30) Foreign Application Priority Data
Jan. 10, 2007 (JP) 2007-002728

(51) Int. Cl. G04C 11/02

(52) U.S. Cl. 368/47

(57) ABSTRACT

A time adjustment device has a reception unit that receives a prescribed signal containing time information transmitted by a base station, a displayed time information adjustment unit that adjusts an information display unit for displaying the time based on the time information contained in the prescribed signal, and location-related information adjustment unit that adjusts a location-related information display unit that displays location-related information for the base station based on the time information contained in the prescribed signal.

### CROSS-REFERENCE TO RELATED APPLICATIONS

Japanese Patent application No. 2007-002728 is hereby incorporated by reference in its entirety.

### BACKGROUND

1. Field of Invention

The present invention relates to a time adjustment device that adjusts the time based on time information contained in signals transmitted from the base station of a CDMA (Code Division Multiplex Access) cell phone network, for example. The invention also relates to a timepiece having the time adjustment device, and to a time adjustment method.

2. Description of Related Art

Time information is contained in signals transmitted to cell phones from the base stations in modern CDMA cell phone networks. This time information is extremely precise time information that matches the GPS time, which is based on the atomic clocks on GPS (Global Positioning System) satellites.

Japanese Unexamined Patent Appl. Pub. JP-A-2000-321383 (see the abstract) teaches a terminal that acquires the GPS time data transmitted from a base station of a CDMA cell phone network, and uses the GPS time data to correct the time kept by an internal clock.

To adjust this time data, information related to the location of the user, such as time difference information, is also transmitted from the base stations of the CDMA cell phone networks, and this information about the location of the user is also desirably corrected immediately.

A problem that occurs when correcting this time data, however, is that the user may not know with which country or region the time is synchronized.

### SUMMARY

The time adjustment device, the timepiece having the time adjustment device, and the time adjustment method of the invention enable also showing the user information related to the location of the user when correcting the time data based on information acquired from a base station.

A time adjustment device according to a first aspect of the invention has a reception unit that receives a prescribed signal containing time information transmitted by a base station, a displayed time information adjustment unit that adjusts an information display unit for displaying the time based on the time information contained in the prescribed signal, and location-related information adjustment unit that adjusts a location-related information display unit that displays location-related information for the base station based on the time information contained in the prescribed signal.

This aspect of the invention has a displayed time information adjustment unit that adjusts an information display unit for displaying the time based on the time information contained in the prescribed signal, and a location-related information adjustment unit that adjusts a location-related information display unit that displays location-related information for the base station based on the time information contained in the prescribed signal.

As a result, the time adjustment device can adjust an information display unit that displays the time based on time information contained in a prescribed signal received from a base station, and a location-related information adjustment unit can quickly adjust a location-related information display unit that displays location-related information based on the time information contained in the prescribed signal.

An information display unit that displays the time based on a prescribed signal that contains time information transmitted from a base station can be adjusted, information related to the location of the user can also be corrected, and the user can know the current location.

Preferably, the time adjustment device also has a local time difference information storage unit that stores local time difference information that is contained in the time information and denotes the time difference between the location of the base station and the Universal Time Code, and the local time difference information is displayed on the location-related information display unit.

This arrangement has a local time difference information storage unit that stores local time difference information that is contained in the time information and denotes the time difference between the location of the base station and the Universal Time Code, and the local time difference information is displayed on the location-related information display unit.

The user can thus quickly know the time difference at the present location because local time difference information that is the time difference to the region where the base station used by the user is located is displayed.

Yet further preferably, the time adjustment device described also has a local time-difference-correlated region name information storage unit that stores local time-difference-correlated region name information relating the local time difference information with corresponding region name information, and the local time-difference-correlated region name information related to the local time difference information is displayed on the location-related information display unit.

In this aspect of the invention the location-related information display unit displays local time-difference-correlated region name information related to the local time difference information from a local time-difference-correlated region name information storage unit that stores local time difference information that is contained in the time information which is contained in a prescribed signal transmitted from a base station, and local time-difference-correlated region name information that relates region name information to local time difference information.

As a result, local time-difference-correlated region name information related to local time difference information, which is the time difference to the region where the base station used by the user is located is displayed and the user can quickly know the location of the base station used in the region.

Yet further preferably, the local time-difference-correlated region name information storage unit stores a plurality of local time-difference-correlated region name information relating time difference information for plural regions with the corresponding region name information.

This aspect of the invention stores a plurality of local time-difference-correlated region name information relating information for plural regions with the corresponding region name information.

Based on time information contained in a prescribed signal transmitted from a base station, the location-related information display unit can quickly relate the local time difference information contained in the time information with the corresponding region name when correcting and displaying the location-related information for the base station.

In another aspect of the invention the time adjustment device also has a local time difference information confirmation unit that confirms if the local time difference information is in the local time difference information storage unit, and the location-related information display unit displays based on the local time difference information confirmed by the local time difference information confirmation unit.

Because this aspect of the invention has a local time difference information confirmation unit that confirms if the local time difference information is in the local time difference information storage unit, and the location-related information display unit displays based on the local time difference information confirmed by the local time difference information confirmation unit, the local time difference information that was stored when the time was corrected can be displayed on the location-related location, information display unit when in an environment where signals from the base station cannot be received.

In a time adjustment device according to another aspect of the invention the location-related information in the location-related information display unit can be input by means of an external input unit that can be operated by the user.

This arrangement is convenient for the user because the user can set the location-related information by operating an external input unit.

Yet further preferably, the region name information is country-of-use information or city-of-use information.

Because the region name information in the local time-difference-correlated region name information storage unit that stores local time-difference-correlated region name information that relates region name information to local time difference information, which is the time difference to the region where the base station used by the user is located is country-of-use information or city-of-use information, the user can quickly know the region in which the base station being used is located.

Another aspect of the invention is a timepiece device that has a time adjustment device and includes a reception unit that receives a prescribed signal containing time information transmitted by a base station, a displayed time information adjustment unit that adjusts an information display unit for displaying the time based on the time information contained in the prescribed signal, and a location information adjustment unit that adjusts a location information display unit that displays location information for the base station based on the time information contained in the prescribed signal.

Another aspect of the invention is a time adjustment method for a time adjustment device, including a reception unit that receives a prescribed signal containing time information transmitted by a base station, an information display unit that display time, and a location information display unit that displays location information for the base station, wherein the information display unit is adjusted based on the time information contained in the prescribed signal, and the location information display unit is adjusted based on the time information contained in the prescribed signal.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic diagram showing a wristwatch with a time adjustment device as an example of a timepiece having a time adjustment device according to the invention.

FIG. 2 is a schematic diagram showing the main internal hardware arrangement of the wristwatch shown in FIG. 1.

FIG. 3 is a schematic diagram showing the basic arrangement of the CDMA base station signal receiver shown in FIG. 2.

FIG. 4 is a schematic diagram showing the main software configuration of the wristwatch.

FIG. 5 is a schematic diagram showing data stored in the program storage unit in FIG. 4.

FIG. 6 is a schematic diagram showing data stored in the first data storage unit in FIG. 4.

FIG. 7 is a schematic diagram showing data stored in the second data storage unit in FIG. 4.

FIG. 8 is a flow chart describing the main operation of the wristwatch according to the invention.

FIG. 9 is flow chart describing the main operation of the wristwatch according to the invention.

FIG. 10 is flow chart describing the main operation of the wristwatch according to the invention.

FIG. 11 describes the synchronization timing of signals transmitted from a CDMA base station.

FIG. 12 is a schematic diagram describing the content of the sync channel message.

FIG. 13A is a schematic diagram describing the CDMA base station signal receiver synchronizing with the pilot channel signal, and FIG. 13B is a schematic diagram describing the relationship between the start timing and a divide-by-64 counter.

FIG. 14 is a schematic diagram describing the process of the frequency division counter frequency dividing the 1.2288 MHz chip rate of the pilot PN to generate Walsh code (32).

FIG. 15 shows an example of adjusting the location-related information in the location-related information display unit of a timepiece with a time adjustment device according to a preferred embodiment of the invention.

FIG. 16 shows another example of adjusting the location-related information in the location-related information display unit of a timepiece with a time adjustment device according to a preferred embodiment of the invention.

FIG. 17 is a local time and country correlation table that is an example of local time difference and region correlation information that is stored in the local time difference and region correlation information storage unit of a timepiece with a time adjustment device according to the invention.

### DESCRIPTION OF THE PREFERRED EMBODIMENTS

A preferred embodiment of the present invention is described below with reference to the accompanying figures.

The embodiment described below has various technically desirable limitations because it is a specific preferred embodiment of the invention, but the scope of the invention is not limited to the following embodiment unless some aspect described below is specifically said to limit the invention.

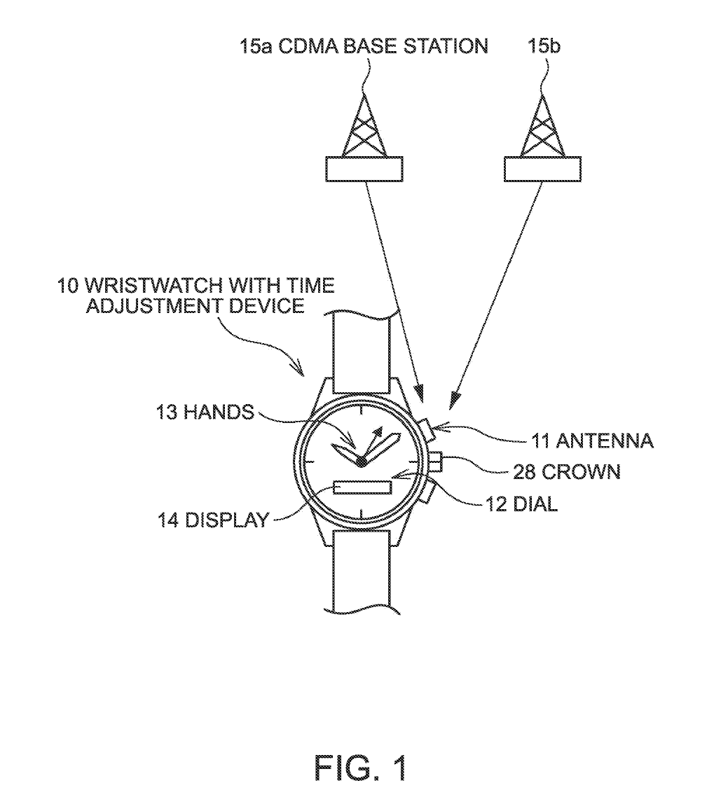

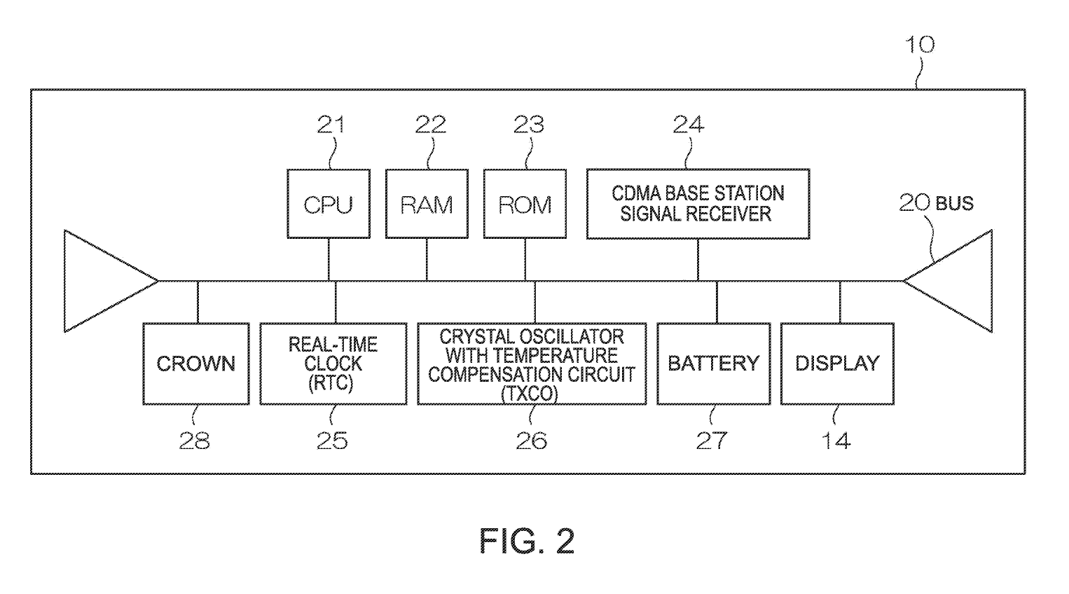

FIG. 1 is a schematic diagram showing a wristwatch with a time adjustment device 10 (referred to below as simply a wristwatch) as an example of a timepiece with a time adjustment device according to the present invention, and FIG. 2 is a block diagram describing the main internal hardware configuration of the wristwatch 10 shown in FIG. 1.

As shown in FIG. 1 the wristwatch 10 has a dial 12 on the face, hands 13 including a long hand and a short hand, and a display 14 such as an LED for displaying messages. The display 14 could be an LCD or analog display, for example, instead of an LED.

As also shown in FIG. 1 the wristwatch 10 has an antenna 11, and this antenna 11 is arranged to receive signals from a base station such as CDMA base stations 15a and 15b. More specifically, these CDMA base stations 15a and 15b are base stations on a CDMA cell phone network.

The wristwatch 10 in this embodiment of the invention does not have a cell phone function and therefore does not enable voice communication with the CDMA base stations 15a, but receives time information, for example, from the signals transmitted from the CDMA base stations 15a and adjusts the time based on these received signals. The content of the signals from the CDMA base stations 15a is further described below.

As also shown in FIG. 1 the wristwatch 10 has a crown 28 that can be operated by the user.

This crown 28 is an example of an external input unit that can be operated by the user.

The hardware arrangement of the wristwatch 10 is described next.

As shown in FIG. 2 the wristwatch 10 has a bus 20, and a CPU (central processing unit) 21, RAM (random access memory) 22, and ROM (read-only memory) 23 are connected to the bus 20.

A reception unit for receiving signals from the CDMA base stations 16a, such as CDMA base station signal receiver 24, is connected to the bus 20. The CDMA base station signal receiver 24 has the antenna 11 shown in FIG. 1.

A real-time clock (RTC) 25 that is a timekeeping mechanism rendered as an IC device (semiconductor integrated circuit), for example, and a crystal oscillator with temperature compensation circuit (TCXO) 26, are also connected to the 20.

The dial 12 and hands 13 shown in FIG. 1, and the RTC 25 and TCXO 26 in FIG. 2 are thus an example of a time information display unit for displaying time information.

A battery 27 is also connected to the bus 20, and the battery 27 is a power supply unit for supplying power for communication by the reception unit (such as the CDMA base station signal receiver 24).

The display 14 and the crown 28 shown in FIG. 1 are also connected to the bus 20. The bus 20 is thus an internal bus that has a function for connecting all of the other devices and has addresses and data paths. The RAM 22 is used as working memory by the CPU 21 for executing specific programs and controlling the ROM 23 connected to the bus 20. The ROM 23 stores programs and data.

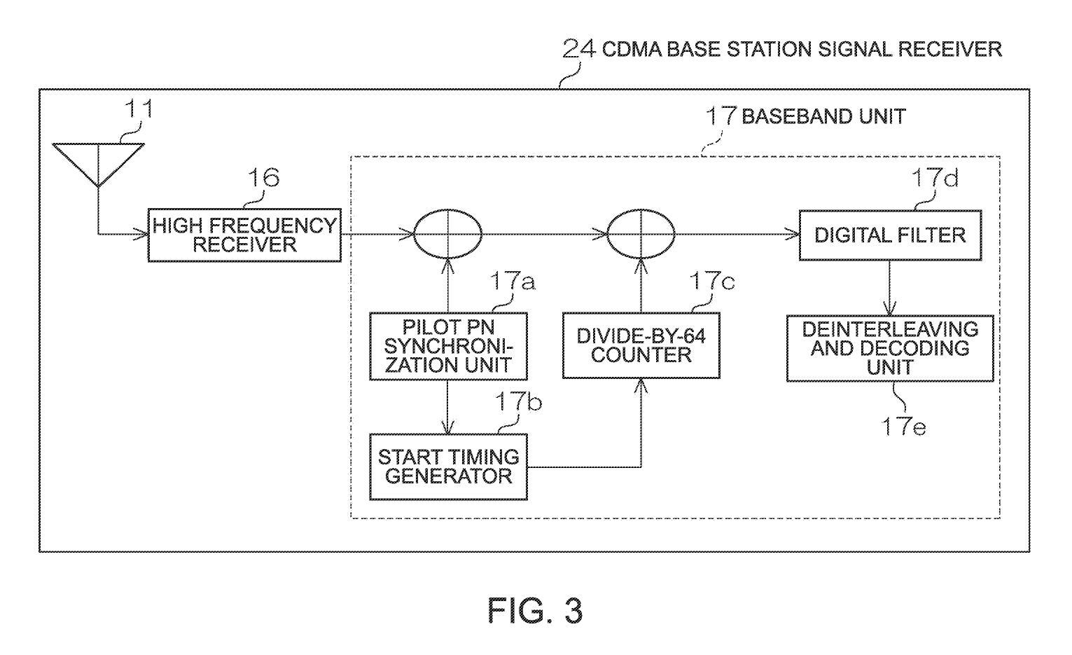

FIG. 3 is a schematic diagram showing the basic arrangement of the CDMA base station signal receiver 24 shown in FIG. 2. As shown in FIG. 3 a high frequency receiver 16 is connected to the antenna 11. This high frequency receiver 16 down-converts signals received by the antenna 11 from the CDMA base stations 15a, for example.

A baseband unit 17 is also connected to the high frequency receiver 16. Inside the baseband unit 17 is a pilot PN synchronization unit 17a. This pilot PN synchronization unit 17a mixes the pilot PN code with the pilot channel signal downloaded by the high frequency receiver 16 for signal synchronization.

A start timing generator 17b is also connected to the pilot PN synchronization unit 17a. The pilot PN synchronization unit 17a inputs the timing at which the signal was synchronized to the start timing generator 17b, and based on this input the start timing generator 17b generates the start timing.

As shown in FIG. 3 the start timing generator 17b is connected to a divide-by-64 counter 17c. The start timing generated by the start timing generator 17b is thus input to the divide-by-64 counter 17c and frequency division starts.

As further described below, the divide-by-64 counter 17c divides the frequency of the pilot PN chip rate, that is, 1.2288 MHz, by 64 and generates Walsh code (32). The resulting Walsh code (32) is mixed with the sync channel signal received by the antenna 11 to extract the time information. Processing these signals is described below.

The start timing generator 17b is an example of a start timing supply unit that supplies the start timing at which the divide-by-64 counter 17c starts frequency dividing the base frequency of, for example, the pilot PN chip rate (1.2288 MHz).

The divide-by-64 counter 17c is a frequency division counter unit that frequency divides the basic unit of a prescribed signal, such as the 1.2288 MHz frequency of the pilot PN signal, and generates a time information extraction signal, such as Walsh code (32).

The baseband unit 17 also has a digital filter 17d and a deinterleaving and decoding unit 17e as shown in FIG. 3. That is, the signal received by the antenna 11 passes the digital filter 17d and then the deinterleaving and decoding unit 17e after mixing the Walsh code (32) as described above, is demodulated, and is extracted as the sync channel message described below.

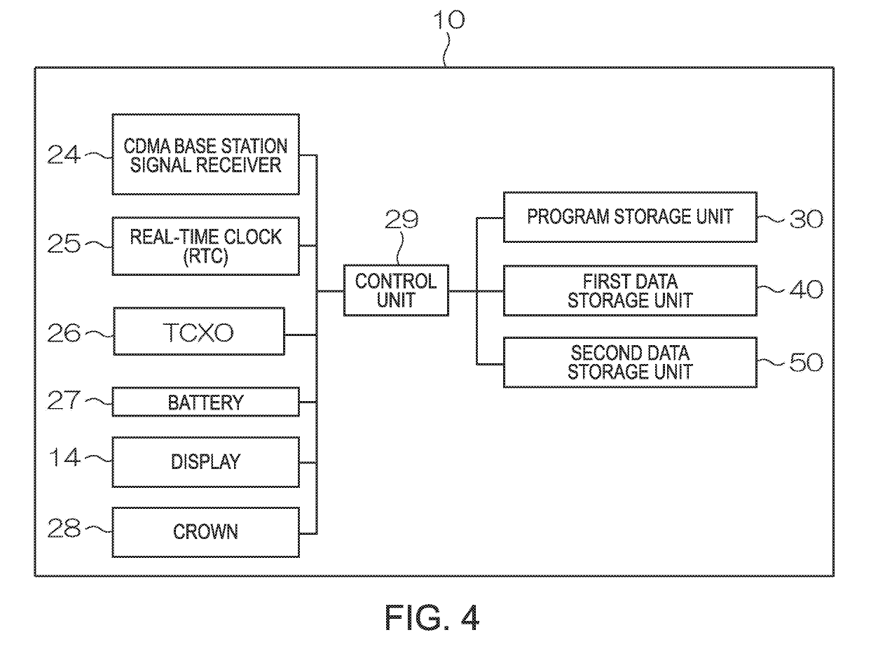

FIG. 4 to FIG. 7 are schematic diagrams showing the main software arrangement of the wristwatch 10. FIG. 4 is an overview.

As shown in FIG. 4 the wristwatch 10 has a control unit 29, and the control unit 29 runs the programs stored in the program storage unit 30 shown in FIG. 4 and processes the data in the first data storage unit 40 and the data in the second data storage unit 50.

Note that the program storage unit 30, the first data storage unit 40, and the second data storage unit 50 are shown separately in FIG. 4, but in practice the data is not stored in separate devices and is shown this way for descriptive convenience only.

In addition, primarily data that is predefined is stored in the first data storage unit 40 in FIG. 4. In addition, primarily data that results from processing the data in the first data storage unit 40 by running the programs shown in the program storage unit 30 is stored in the second data storage unit 50.

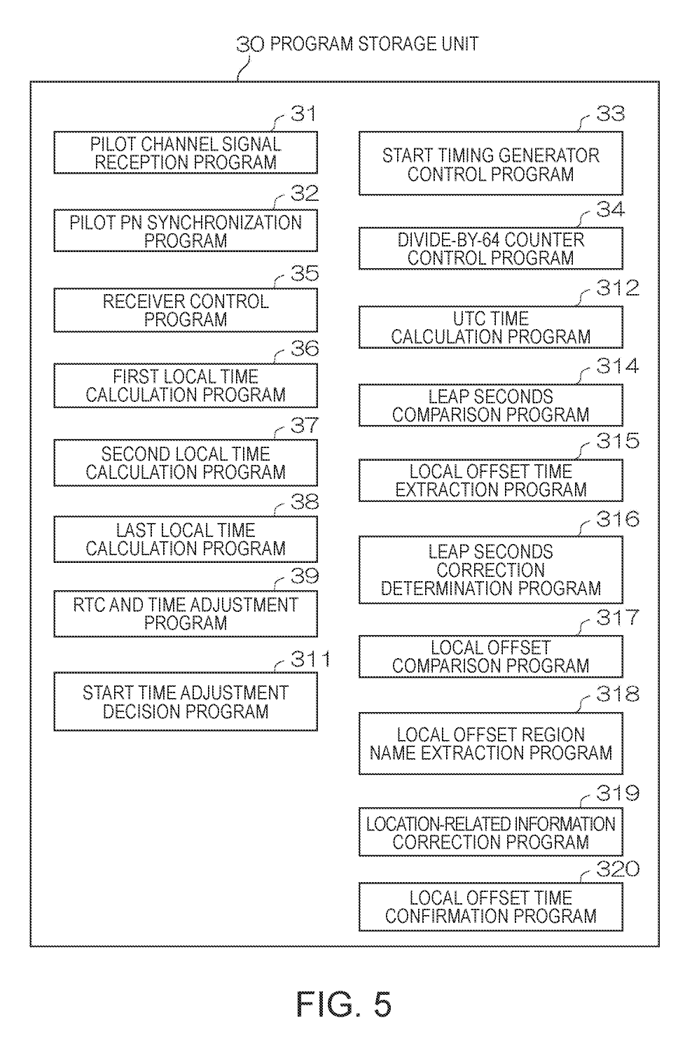

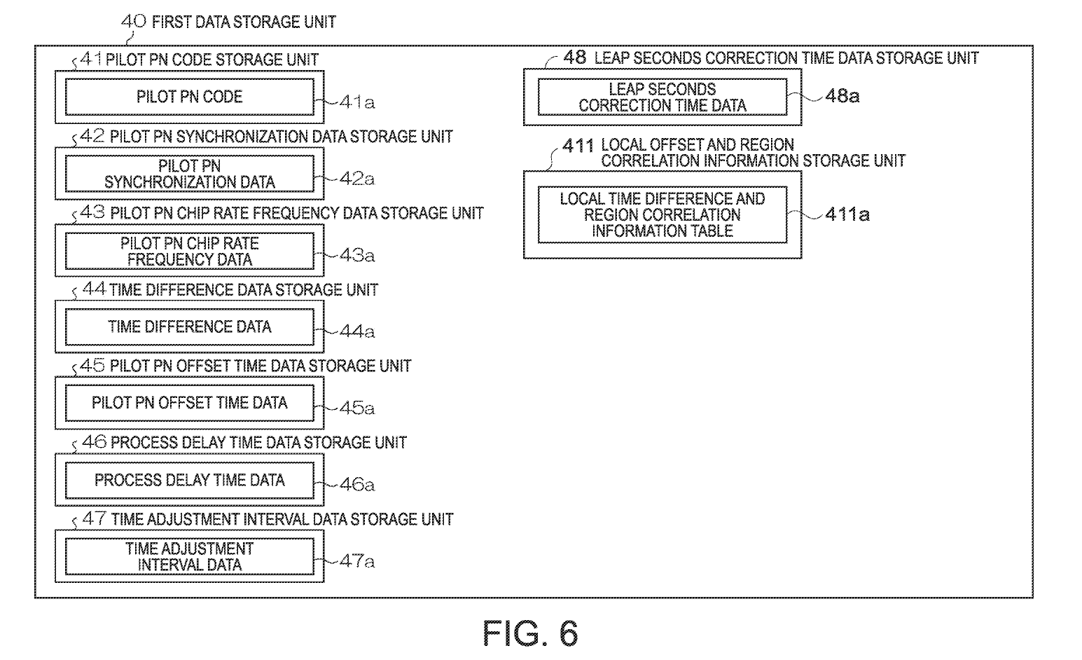

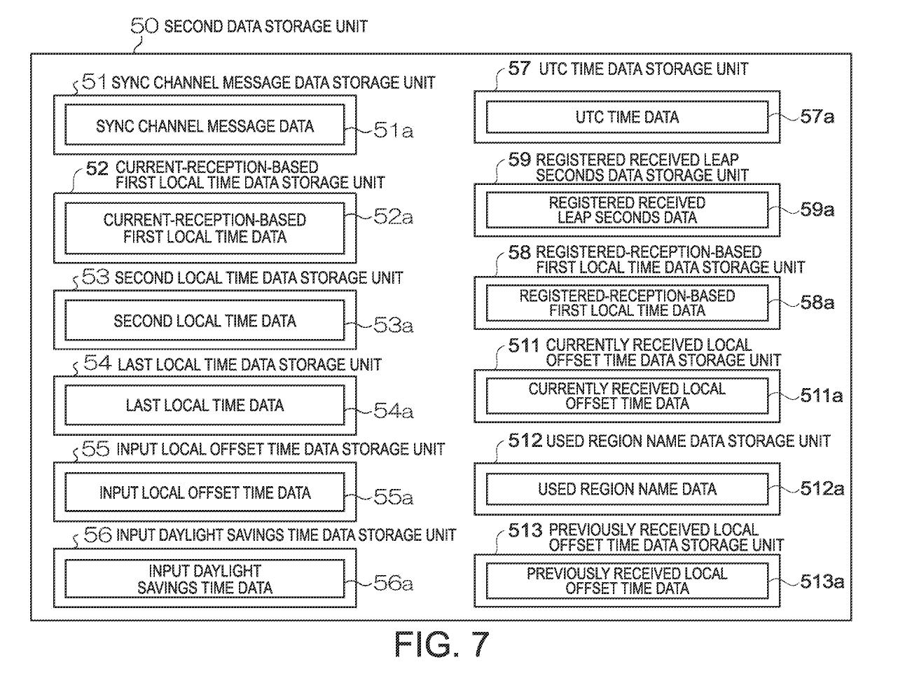

FIG. 5 is a schematic diagram showing the data stored in the program storage unit 30 in FIG. 4, and FIG. 6 is a schematic diagram showing the data stored in the first data storage unit 40 in FIG. 4. FIG. 7 is a schematic diagram showing the showing the data stored in the second data storage unit 50 in FIG. 4.

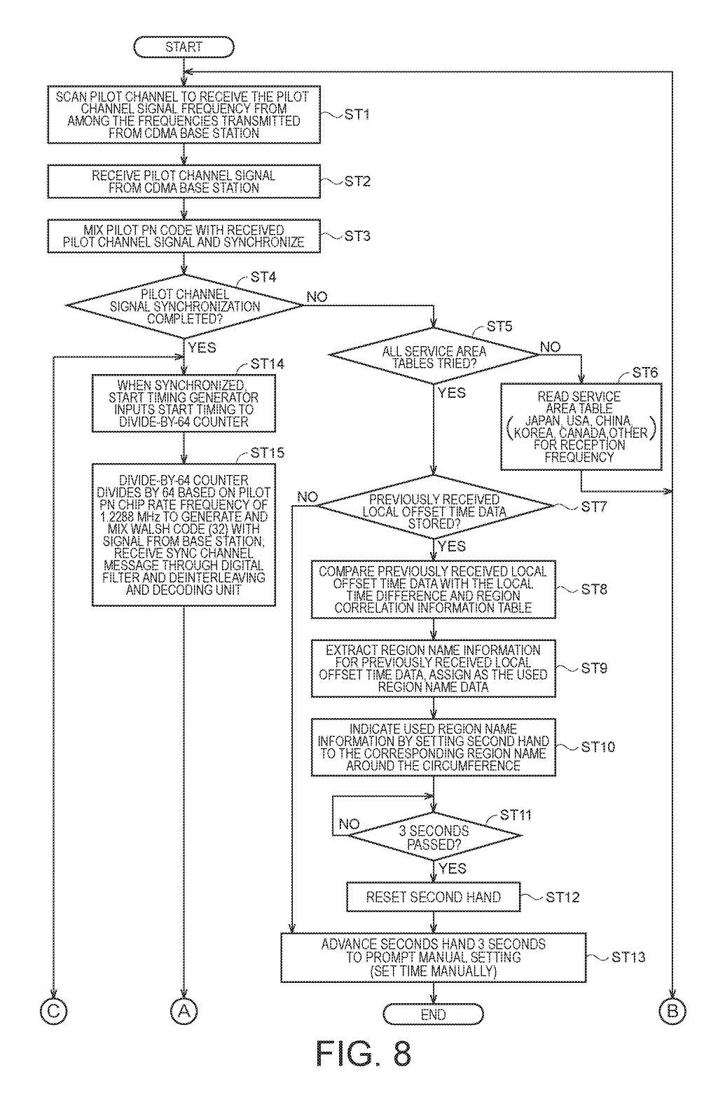

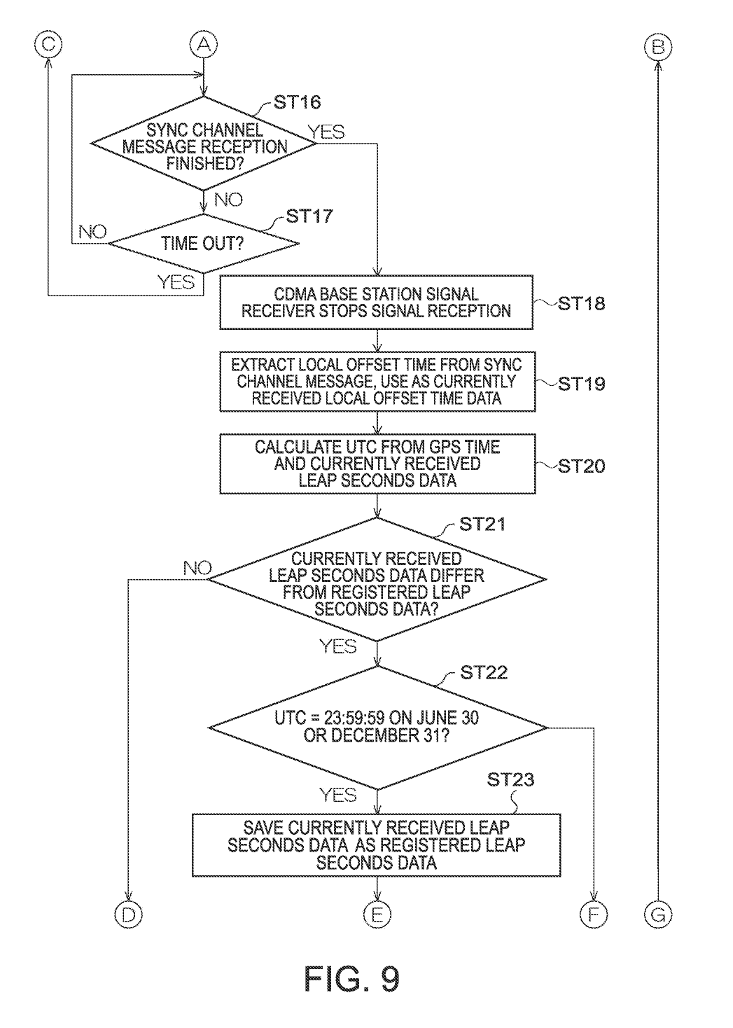

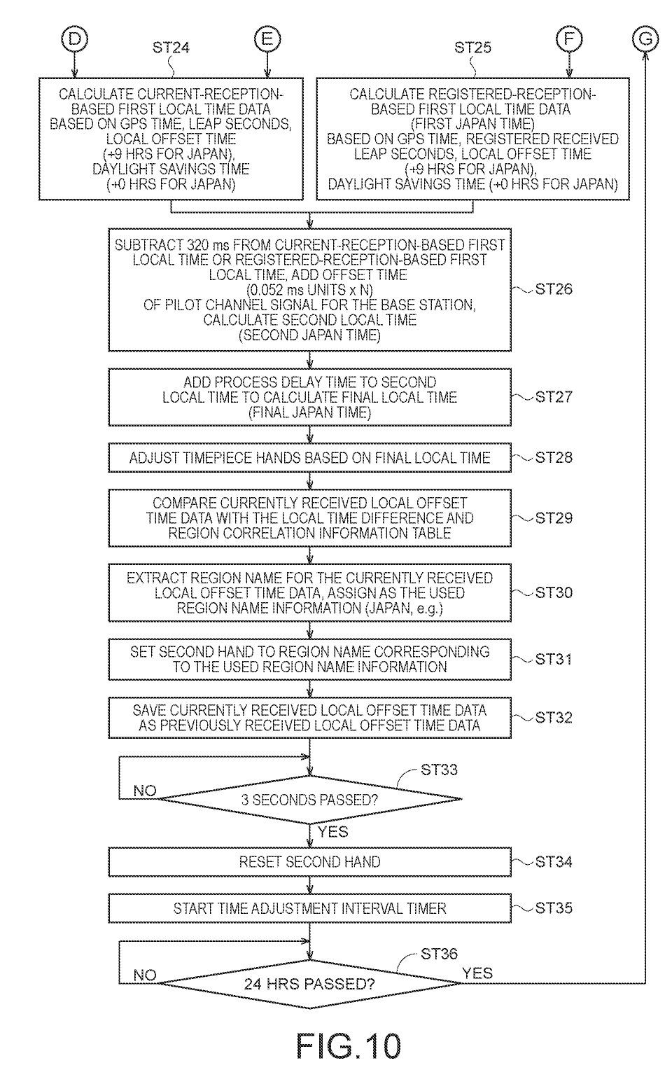

FIG. 8 to FIG. 10 are flow charts describing the main operation of the wristwatch 10 according to this embodiment of the invention.

While describing the operation of the wristwatch 10 according to this embodiment of the invention with reference to the flow charts in FIG. 8 to FIG. 10, the programs and data related to this operation and shown in FIG. 5 to FIG. 7 are also described below.

Before proceeding to the description of the flow charts, the parts of the CDMA cell phone system that are related to the invention are described below.

The CDMA cell phone system started actual operation after the system developed by Qualcomm, Inc. of the United States was adopted in 1993 as the IS95 cell phone standard in the United States. This standard was later revised as IS95A, IS95, and then CDMA2000. A cell phone system conforming to ARIB STD-T 53 is used in Japan.

Because the CDMA system is synchronized on the downlink (from the CDMA base station 15a to the mobile station, wristwatch 10 in this embodiment of the invention), the wristwatch 10 must synchronize with the signals from the CDMA base station 15a. The signals transmitted from the CDMA base station 15a include a pilot channel signal and a sync channel signal. The pilot channel signal is a signal that is transmitted from each CDMA base station 15a at a different timing, such as the pilot PN signal.

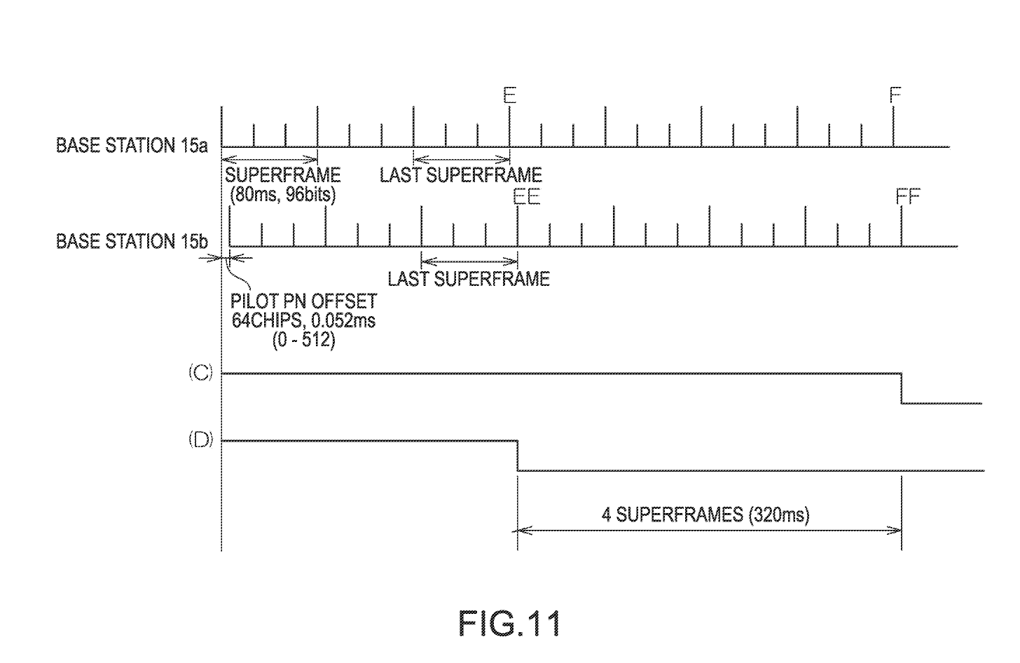

FIG. 11 is a timing chart of the synchronization timing for signals transmitted from the CDMA base stations 15a and 15b.

Because the signals transmitted form the CDMA base stations 15a and 15b are the same, the signal transmission timing of each CDMA base station 15a differs from the signal transmission timing of each other CDMA base station 15a so that it can be determined which CDMA base station 15a transmitted a particular signal.

More specifically, these timing differences are expressed by differences in the pilot PN signal transmitted by the CDMA base station 15a. In FIG. 11, for example, the CDMA base station 15b transmits signals at a timing delayed slightly from the CDMA base station 15a. More specifically, there is a pilot PN offset of 64 chips (0.052 ms).

By each CDMA base station 15a providing a different pilot PN offset that is an integer multiple of 64 chips, the wristwatch 10 can easily determine the CDMA base station 15a from which a signal was received even when there are many CDMA base stations 16a.

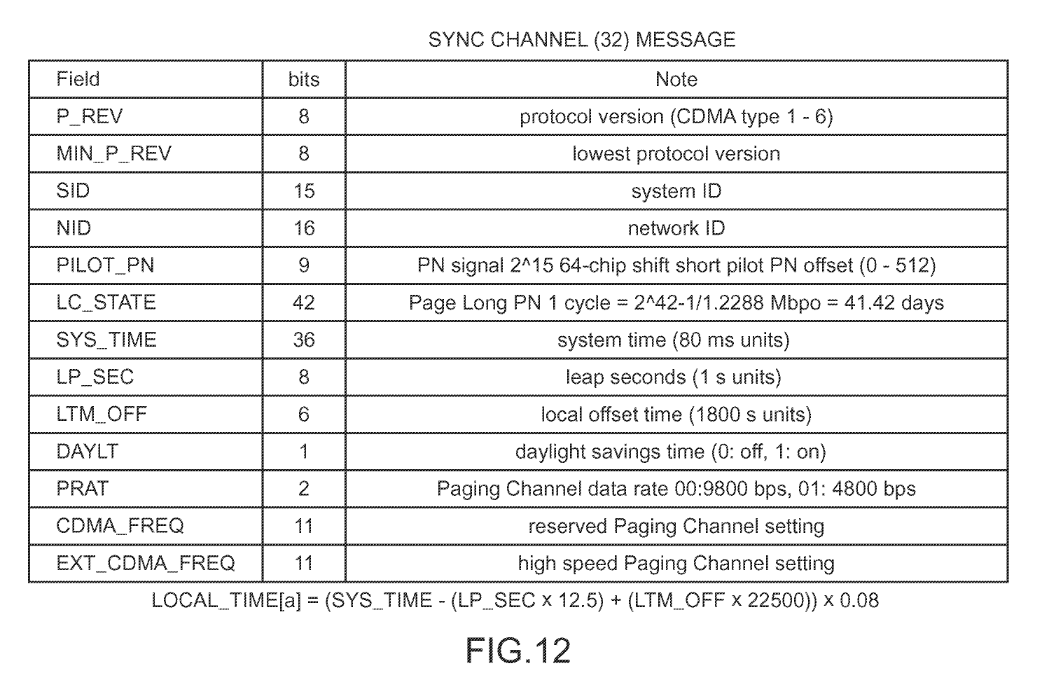

The signals transmitted from the CDMA base station 15a also contain a sync channel signal, which is the sync channel message shown in FIG. 12. FIG. 12 shows the content of the sync channel message.

As shown in FIG. 12, the sync channel message contains data about the pilot PN signal, such as data showing that the pilot PN offset is 64 chips (0.052 ms)×N (0-512). This value is contained in the PILOT_PN field in FIG. 12.

The sync channel message also contains system time information, which is the GPS time.

The system time is the cumulative time in 80 ms units from 0:00 on Jan. 6, 1980. This value is contained in the SYS_TIME field in FIG. 12.

The sync channel message also contains a leap second value for UTC (Universal Time Code) conversion. This value is contained in the LP_SEC field in FIG. 12. For example, this is a value such as “13” seconds or “14” seconds. This leap seconds value is an example of leap seconds information that is time adjustment information contained in the time information and based on the rotation of the Earth, for example.

The sync channel message also contains the local offset time, which is the time difference between the country or region where the wristwatch 10 is located and the UTC. If the country is Japan, for example, a value indicating that the time difference to UTC is +9 hours is stored.

This value is stored in the LTM_OFF field in FIG. 12.

The sync channel message also contains a daylight savings time value indicating if the country or region where the wristwatch 10 is located uses daylight savings time. The value in this example is 0 because Japan does not use daylight savings time. This value is stored in the DAYLT field in FIG. 12.

The pilot PN signal data shown in FIG. 12 is thus base station time difference information for signals transmitted from a particular base station (such as CDMA base station 15a), and the local offset information is region time conversion information for converting to the local time. The daylight savings time data is seasonal time information for converting to the time of the current season.

While the sync channel message shown in FIG. 12 contains data such as described above, the data is transmitted sequentially on the time base. The transmitted signals are transmitted in 80-ms superframe units as shown in FIG. 11, and the last superframe shown in FIG. 11 is the superframe that contains the last data in one sync channel message. The timing of the end of the last superframe in FIG. 11 (the parts denoted E and EE in FIG. 11) is thus the timing of the end of sync channel message reception.

The GPS time in the sync channel message shown in FIG. 12 is not the time at time E in FIG. 11 in the CDMA system, but is the time four superframes (320 ms) later, that is, at time F in FIG. 11.

More specifically, the GPS time is the time at four superframes from the time at the end of the last superframe referenced to the time when the above-described pilot PN offset is 0 chips (0 ms).

This is based on CDMA being a cell phone telecommunication system. More specifically, after the cell phone receives the sync channel message shown in FIG. 12 from a CDMA base station 15a, the cell phone needs to prepare internally for synchronized communication with the CDMA base station 15a.

That is, after preparing to shift to the next stage, standby, the cell phone synchronizes and communicates with the CDMA base station 15a.

Therefore, if the CDMA base station 15a sends a time in the future, such as the time 320 ms later, in advance to allow for this preparation time, and the cell phone receiving this time executes an internal process to prepare for communication and then attempts to synchronize with the CDMA base station 15a, synchronization is easier. In other words, these four superframes (320 ms) are preparation time for the cell phone.

The CDMA cell phone system used by this embodiment of the invention is described above, and the embodiment of the invention is described below with reference to this CDMA cell phone system.

To adjust the time of the wristwatch 10, the CDMA base station signal receiver 24 shown in FIG. 2 of the wristwatch 10 scans the pilot channel in order to receive the pilot channel signal from among the signals transmitted from the CDMA base station 15a shown in FIG. 1.

Then, in ST2, the CDMA base station signal receiver 24 receives the pilot channel signal from the CDMA base station 15a. More specifically, the pilot channel signal reception program 31 in FIG. 5 operates.

The pilot PN code is then mixed with the received pilot channel signal to synchronize in ST3 in FIG. 8 and Walsh code (0) is overlayed (despreading) to get the data.

More specifically, the pilot PN synchronization program 32 in FIG. 5 operates, and the pilot PN synchronization unit 17a in FIG. 3 mixes the same code as the pilot PN code 41a stored in the pilot PN code storage unit 41 shown in FIG. 6 the pilot PN code sent from the CDMA base station 15a) and Walsh code (0) as shown in FIG. 3 to synchronize. Preparing a special code is not necessary at this time because the mixed Walsh code is (0).

Because the pilot PN code is thus contained in the received pilot channel signal, the CDMA base station signal receiver 24 requires the same pilot PN code and Walsh code (0) to receive. The CDMA base station signal receiver 24 can thus synchronize with the pilot channel signal from the CDMA base station 16a, despread, and get data.

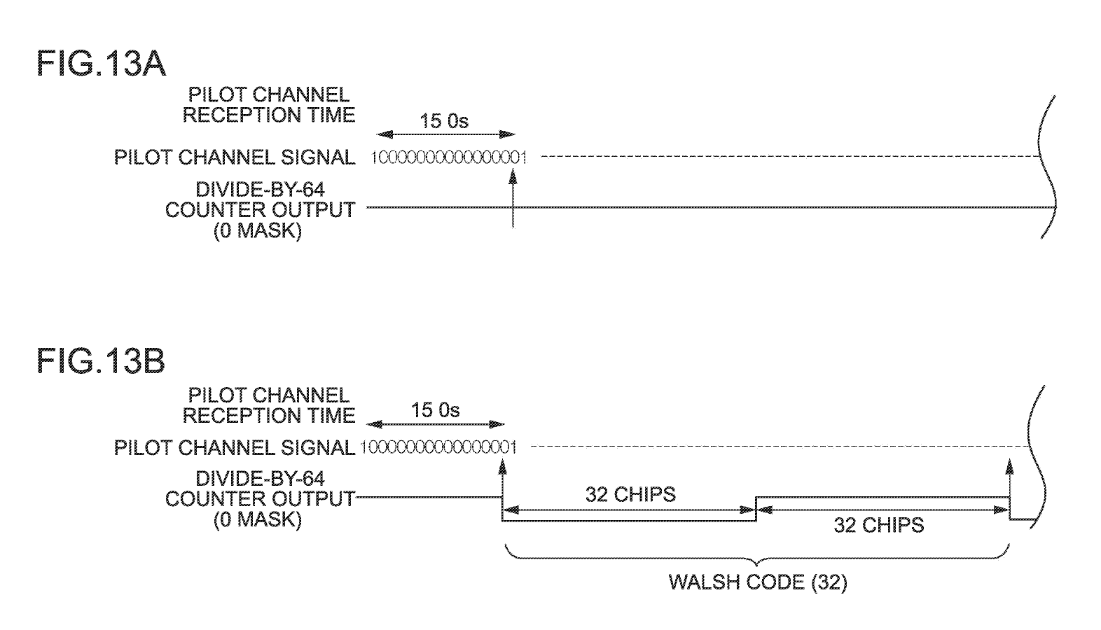

FIG. 13A shows the CDMA base station signal receiver 24 synchronizing with the pilot channel signal.

As shown in FIG. 13A, the pilot channel signal contains a string of 15 consecutive zeroes (0), the last zero (0) (the position indicated by the vertical arrow in FIG. 13A) is used for synchronization, and data for synchronizing to this bit is contained in the pilot PN synchronization data 42a.

Signals synchronized this way are synchronized with a superframe every 80 ms as described in FIG. 11.

The pilot PN synchronization program 32 then determines if synchronization with the pilot channel signal of the CDMA base station 15a is completed in ST4. If synchronization is not finished, the CDMA base station signal receiver 24 determines in ST5 if all service area tables in the wristwatch 10 have been referenced (through one cycle), and if they have not been referenced, control goes to ST6.

The data for CDMA base stations 16a in Japan, the United States, China, and Canada, for example, is referenced in ST6, and the pilot channel is scanned in ST1 based on this data.

For example, if the wristwatch 10 is looking for a CDMA base station 16a in Japan but is actually in the United States, synchronization with the pilot channel is not possible in ST3. Data for the CDMA base stations 16a in the United States is then acquired in ST6, and the pilot channel is scanned in ST1 based on this data.

However, is synchronization with the pilot channel signal is not possible even though all service area tables in the wristwatch 10 have been referenced in ST6, control goes to ST7. ST7 determines if the previous local offset time is stored.

More specifically, the local offset time confirmation program 320 in FIG. 5 determines if the previously received local offset time data 513a is stored in the previously received local offset time data storage unit 513 in FIG. 7.

As described below the previously received local offset time data 513a is the local offset time when the wristwatch 10 previously adjusted the time. More specifically, it is the local offset time that is extracted from the sync channel message to adjust the time as described below after synchronization with the pilot channel signal from the CDMA base station 15a ends. It is also the local offset time that is stored in the previously received local offset time data storage unit 513 after the used region name data 512a of the wristwatch 10 is displayed. As described below the local offset time extracted from the sync channel message is first stored as the currently received local offset time data 511a in the currently received local offset time data storage unit 511 in FIG. 7. After the used region name data 512a of the wristwatch 10 is displayed, the currently received local offset time data 1la becomes the previously received local offset time data 513a.

More specifically, a previously received local offset time data storage unit 513 that stores the previously received local offset time data 513a, which contains the local offset time from the LTM_OFF field of the sync channel message (see FIG. 12) received from the CDMA base station 15a, is disposed in the second data storage unit 50 as shown in FIG. 7.

The local offset time confirmation program 320 in FIG. 5 thus looks for the previously received local offset time data 513a in the previously received local offset time data storage unit 513 in FIG. 7 and determines if the data is stored.

The local offset time confirmation program 320 is an example of a local time difference information confirmation unit.

Therefore, if synchronization with the pilot channel signal is not possible even though all service area tables stored in the wristwatch 10 have been referenced, that is, signals cannot be received from the base station, the local offset time confirmation program 320, which is an example of a local time difference information confirmation unit, confirms the presence of previously received local offset time data 513a, which is an example of local time difference information, in the previously received local offset time data storage unit 513, which is an example of a local time difference information storage unit, and the used region name data 512a, which is location-related information, can be displayed in the regional location information display unit based on the confirmed previously received local offset time data 513a

Control then goes to ST8 and the previously received local offset time data 513a in FIG. 7 is compared with the local time difference and region correlation information table 411a in FIG. 6.

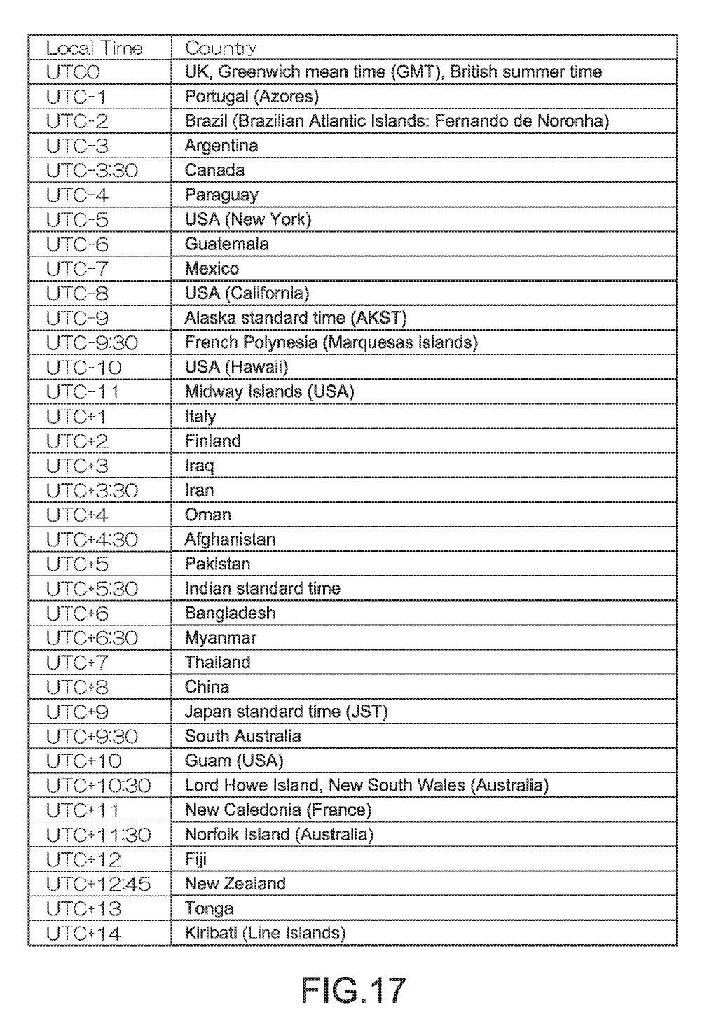

More specifically, the local offset comparison program 317 in FIG. 5 compares the previously received local offset time data 513a in the previously received local offset time data storage unit 513 in FIG. 7 with the local offset time (the data in the column labelled Local Time in the table in FIG. 17) in the local time difference and region correlation information table 411a of the local offset and region correlation information storage unit 411 in FIG. 6 and gets the corresponding region name information (the data in the column labelled Country in the table in FIG. 17).

The local time difference and region correlation information table 411a stores, for example, the local offset times displayed in the Local Time column and a country or region that uses that Local Time as shown in FIG. 17.

The local offset and region correlation information storage unit 411 thus stores the local offset time (also referred to below as simply the “local offset”) and a country or region that uses that local offset time. Therefore, if the previously received local offset time data 513a is data indicating +9 hours from UTC, for example, the region is immediately known to be Japan.

The local offset and region correlation information storage unit 411 is an example of a local time-difference-correlated region name information storage unit, and the local time difference and region correlation information table 411a is an example of a plurality of local time-difference-correlated region name information that relates time difference information for plural regions with the corresponding region name information.

The local offset comparison program 317 is an example of a location-related information adjustment unit. The local offset comparison program 317 can therefore compare the local time difference information that is contained in the time information (the previously received local offset time data 513a in this case) with the local time difference and region correlation information table 411a to quickly relate the region name corresponding to the previously received local offset time data 513a.

The region name information detected in ST8 is then assigned as the used region name data 512a in FIG. 7 in ST9. More specifically, the local offset region name extraction program 318 in FIG. 5 stores the region name information detected in ST8 to the used region name data storage unit 512 as the used region name data 512a in FIG. 7.

The used region name data 512a is then indicated in ST10 from among the region name indications 100a, 100b, and 100c, for example, provided around the outside part 10b of the wristwatch 10 by, for example, driving the second hand to point to the region name indication 100a, 100b, or 100c corresponding to the used region name data 512a. More specifically, the location-related information correction program 319 in FIG. 5 moves the second hand to point to the region name indication 100a, 100b, or 100c corresponding to the used region name data 512a stored in the used region name data storage unit 512 from among the region name indications 100a, 100b, and 100c, for example, provided around the outside part 10b of the wristwatch 10.

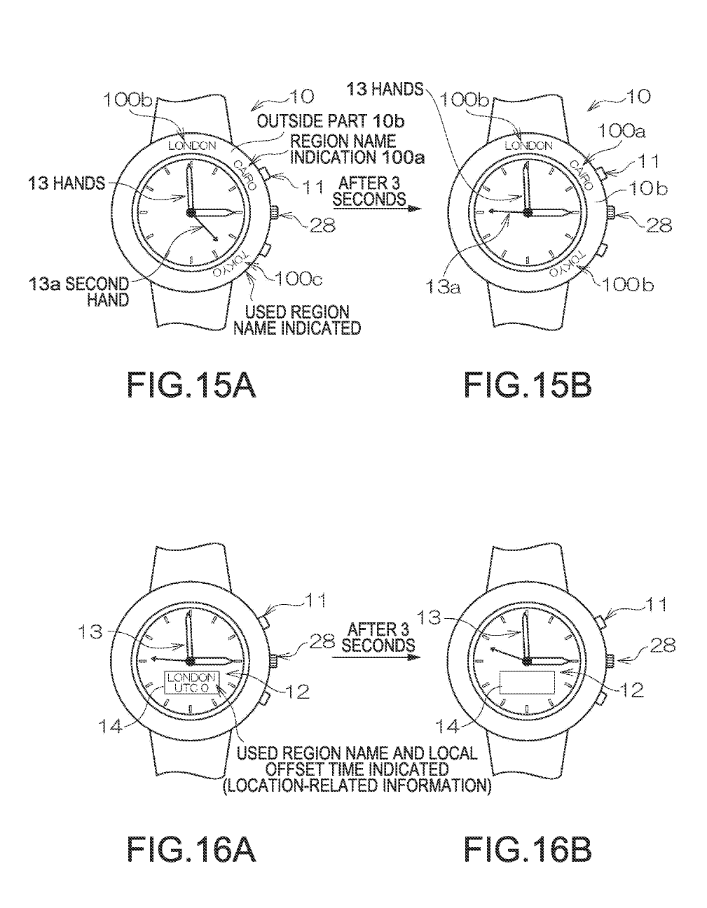

As shown in the example in FIG. 15, if the previously received local offset time data 513a is data indicating +9 hours from UTC, the region name is known to be Japan from the local time difference and region correlation information table 411a. Region name information indicating Japan is stored as the used region name data 512a in the used region name data storage unit 512. Then, as shown in FIG. 16A, Japan (indicated as TOKYO in FIG. 15) is indicated by the second hand 13a of the hands 13 from among the region name indications 100a, 100b, and 100c on the outside part 10b of the wristwatch 10, thus indicating for the user that the region is TOKYO, that is, Japan. The second hand 13a is held in this position for 3 seconds to inform the user.

Control then goes to ST11 to display the used region name information for three seconds, and the second hand is then returned to the original position in ST12 as shown in FIG. 15B.

Control then goes to ST13. To indicate for the user that the time has not been adjusted, the seconds hand in FIG. 1 is moved 3 seconds, for example, in ST7 to inform the user. Adjusting the time is then left to the user, and operation ends. The user of the wristwatch 10 can thus be informed that something is different from usual.

Because the time has not been adjusted in this case, the user knows that the used region name information displayed in ST10 is displayed according to the previously received local offset time data 513a. In this situation the user can manually input the used region name data 512a to the used region name data storage unit 512 by operating the crown 28 of the wristwatch 10, for example.

The crown 28 is an example of an external input unit. The used region name data 512a is an example of location-related information. Indicating the region name indication 100a, 100b, or 100c on the outside part 10b of the wristwatch 10 with the second hand 13a is an example of a location-related information display unit. The location-related information correction program 319 is an example of location-related information adjustment unit.

As a result, even when signals from the base station cannot be received, the used region name data 512a, which is location-related information, can be displayed on the location-related information display unit based on the previously received local offset time data 513a, which is local time difference information, that was stored when the time was previously adjusted.

If synchronization with the pilot channel signal is completed in ST4, control goes to ST14 and the start timing generator 17b inputs the start timing to the divide-by-64 counter 17c.

In this case the start timing generator control program 33 in FIG. 5 operates to generate and input the start timing to the divide-by-64 counter 17c in FIG. 3.

This is shown and described more specifically in FIG. 13B. FIG. 13B schematically describes the relationship between the start timing and the operation of the divide-by-64 counter 17c.

As shown in the figure, the divide-by-64 counter in FIG. 13B outputs at the synchronization timing of the pilot channel signal in FIG. 13A as indicated by the vertical arrow in the figure, and the start timing signal is also input to the divide-by-64 counter 17c at the timing indicated by this vertical arrow.

In ST9 the divide-by-64 counter 17c starts operating and frequency4 dividing at the start timing input from the start timing generator 17b.

In this case the divide-by-64 counter 17c operates according to the divide-by-64 counter control program 34 in FIG. 5, divides the pilot PN chip rate frequency data 43a (1.2288 MHz) stored in the pilot PN chip rate frequency data storage unit 43 in FIG. 6 by 64, and generates a code as shown in FIG. 13B.

The length of this code is 64 chips including a 0 signal for the first 32 chips and a 1 signal for the second 32 chips, and is thus the same as the Walsh code (32) for getting data from the sync channel message in FIG. 12.

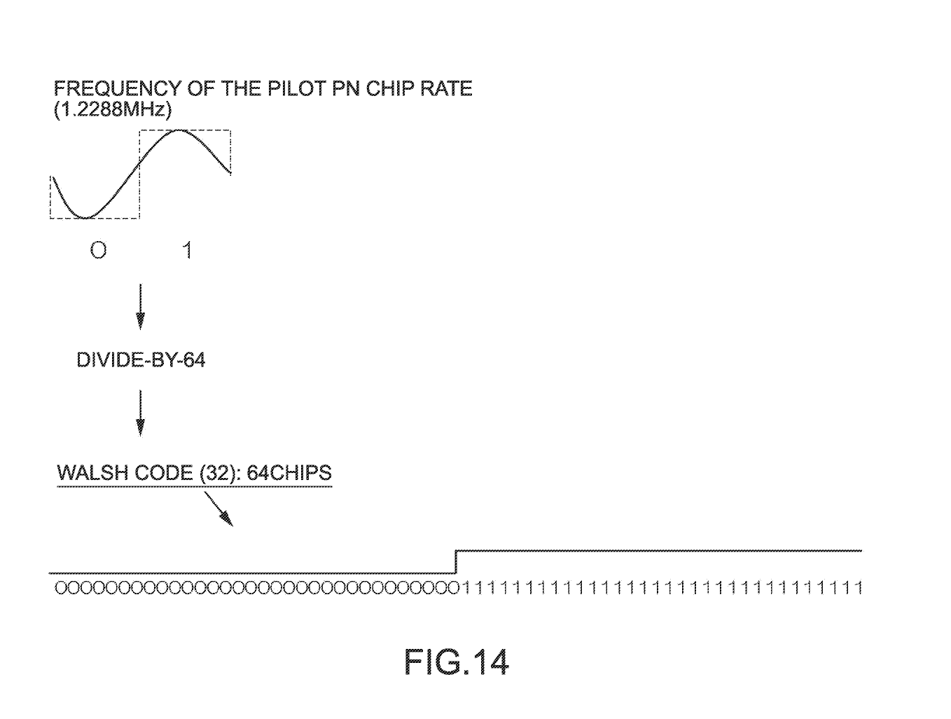

FIG. 14 schematically describes the process whereby the divide-by-64 counter 17c divides the pilot PN chip rate of 1.2288 MHz and generates the Walsh code (32).

As shown in FIG. 14 the pilot PN chip rate of 1.2288 MHz can be expressed as a digital signal of 0s and 1s.

When this 1.2288 MHz signal is divided by 64 by the frequency division counter 17c, the result is the Walsh code (32) of which the 32 chips in the first half are 0s and the 32 chips in the second half are is as shown in FIG. 13.

In ST15, the pilot PN code is first mixed by the sync channel signal, that is, the signal received form the CDMA base station 15a, and the signal is despread using the Walsh code (32) generated by the divide-by-64 counter 17c at the synchronization timing that can be recognized from the beginning of the pilot PN code. The signal is then passed through the digital filter 17d and deinterleaving and decoding unit 17e and interpreted to get the sync channel message in FIG. 12.

As shown in FIG. 12 the sync channel message contains time information (including the SYS_TIME). The signal transmitted from the CDMA base station 15a described above is therefore an example of a prescribed signal containing time information, and the time information can be extracted using the Walsh code (32) from the signal transmitted from the CDMA base station 15a.

The divide-by-64 counter 17c in FIG. 3 is an example of a time information extraction signal supply unit that supplies only the time information extraction signal, that is, Walsh code (32).

In this embodiment of the invention as shown in FIG. 13A and FIG. 13B, the CDMA base station 15a transmits a pilot channel signal indicating the starting part of the sync channel signal (the part indicated by the vertical arrow in FIG. 13), which is a prescribed signal containing time information, with the sync channel signal, and the start timing generator 17b supplies the start timing, which is a start signal, referenced to the pilot channel signal to the divide-by-64 counter 17c.

Whether receiving the sync channel message is completed is then determined in ST16. If sync channel message reception is not completed, whether reception timed out is determined in ST17. If reception timed out, the sync channel message is received again in ST14.

This embodiment of the invention can thus generate the Walsh code (32) that is required to extract the sync channel message from the sync channel signal transmitted from the CDMA base station 15a by means of the divide-by-64 counter 17c and does not require a Walsh code generator to generate the 64 types of Walsh codes as is required by the related art.

The circuit synchronize can therefore be reduced and power consumption can be reduced.

More specifically, the divide-by-64 counter in this embodiment of the invention can generate the Walsh code (32) as shown in FIG. 13B and FIG. 14 by simply frequency dividing the reference frequency of 1.2288 MHz, which is the pilot PN chip rate. The invention can therefore be realized using an extremely simple circuit arrangement and power consumption in particular can be reduced.

In addition, because frequency dividing by the divide-by-64 counter 17c is based on the start timing signal from the start timing generator 17b, which is referenced to the pilot PN signal synchronization timing, the sync channel message can be reliably extracted from the sync channel signal.

If it is determined in ST16 that sync channel message reception finished, control goes to ST18 and signal reception by the CDMA base station signal receiver 24 in FIG. 3 is stopped. More specifically, the receiver control program 35 operates to stop the CDMA base station signal receiver 24 from receiving signals from the CDMA base station 15a. Signal reception thus ends at the timing of the end of the last superframe denoted by E and EE in FIG. 11.

This results in the wristwatch 10 receiving the entire sync channel message shown in FIG. 12, and this sync channel message is stored in the sync channel message data storage unit 51 in FIG. 7 as the sync channel message data 51a.

Control then goes to ST19. In ST19 the local offset time in the LTM_OFF field of the received sync channel message is extracted and stored. More specifically, the local offset time extraction program 315 in FIG. 5 extracts the value in the value of the LTM_OFF field, which is the local offset time, in the received sync channel message (see FIG. 12), and stores the extracted value as the currently received local offset time data 511a in FIG. 7 to the currently received local offset time data storage unit 511. The currently received local offset time data 511a is an example of local time difference information.

Control then goes to ST20. From ST20 is the process for producing the time adjustment data and actually adjusting the time based on information in the sync channel message already acquired from the CDMA base station 15a.

The data for adjusting the time is produced using the leap seconds data shown in FIG. 12 in the sync channel message. The leap seconds data in FIG. 12 is therefore assumed to be correct. However, the leap seconds data in the sync channel message in FIG. 12 is often not accurate.

More specifically, the GPS time (SYS_TIME) is a time value that does not consider the Earth's rotation, the time must therefore be corrected to get the actual time on Earth, and this adjustment data is the leap seconds value. However, this leap seconds data is typically not accurately changed at the CDMA base station 15a when the data is implemented, such as at 0:00 or 9:00 a.m. on January 1, and the CDMA base station 15a data is usually changed sometime before, such as approximately a maximum six months in advance.

If the leap seconds value that is to be applied from 0:00 on January 1 of the next year is “14 seconds,” for example, and the leap seconds value used until then is “13 seconds,” the new leap seconds value of “14 seconds” is already changed in the sync channel data in July of the previous year.

As a result, the time will be 1 second late until 0:00 on January 1 of the next year, and the time cannot be accurately adjusted.

The following process is therefore executed.

First, in ST20, the GPS time SYS_TIME and the leap seconds LP_SEC, such as “14” seconds, are first acquired from the received sync channel message (sync channel message 61a in FIG. 7), and the UTC time (Universal Time Code) is calculated.

The UTC is the year, month, day, hour, minute, and second of Greenwich Mean Time.

More specifically, the UTC time calculation program 312 in FIG. 6 operates and the UTC is calculated based on the GPS time and the leap seconds value.

The calculated UTC time is then stored as the UTC time data 57a in FIG. 7 to the UTC time data storage unit 57.

Whether the leap seconds data that was received differs from the registered leap seconds data is then determined in ST21.

More specifically, a registered received leap seconds data storage unit 59 that stores the registered received leap seconds data 59a is provided in the second data storage unit 50 as shown in FIG. 7 for remembering the leap seconds value of the sync channel message (see FIG. 12) that was previously received from the CDMA base station 15a.

The leap seconds comparison program 314 in FIG. 5 then compares the leap seconds value in the sync channel message that was just received in ST15 above with the registered received leap seconds data 59a, and determines if the values are the same.

For example, the registered received leap seconds data of 13 seconds was received on August 20, and 14 seconds is received as the current leap seconds data on August 30, the registered received leap seconds data and the currently received leap seconds data are different.

In this case the “14 second” value is known to be the leap seconds value that should be used, for example, from 0:00 of January 1 of the next year.

The registered received leap seconds data storage unit 59 and the sync channel message data storage unit 51 are thus an example of a leap seconds information storage unit. The leap seconds comparison program 314 is an example of a leap seconds change determination unit.

The registered received leap seconds data 59a can also be manually corrected by the user of the wristwatch 10.

If the leap seconds data is determined to be different in ST21, the leap seconds data that was received has changed and is the value for the next year, for example. Whether this leap seconds data should be used or not is then determined in ST22.

Whether the UTC time data 57a indicates 23:59:59 on June 30 or December 31 is then determined in ST22.

More specifically, whether the time has come when the currently received leap seconds data that was received in ST15 should actually be used (applied) is determined.

More specifically, the leap seconds correction determination program 316 makes this decision based on the UTC time data 57a in FIG. 7 and the leap seconds correction time data 48a in FIG. 6. Data such as 23:59:59 on June 30 or December 31 is stored in the leap seconds correction time data 48a as the correction time used for evaluation.

The leap seconds correction time data storage unit 48 in FIG. 6 is an example of a leap seconds application time information storage unit.

If in ST22 the UTC time data 57a indicates the time when the received leap seconds value is to be used, the leap seconds data that was just received (such as “14 seconds” in this example) is stored as the registered received leap seconds data 59a (ST23), and control goes to ST24.

In ST24 the current-reception-based first local time data 52a in FIG. 7 is calculated by the first local time calculation program 36 in FIG. 5.

The current-reception-based first local time data 52a is described next.

Because the wristwatch 10 in this embodiment of the invention is in Japan, for example, the GPS time, the currently received leap seconds, local offset time (UTC +9 in the case of Japan), and daylight savings time adjustment (0 hours in this example because there is no daylight savings time in Japan) are extracted from the sync channel message data 51a in FIG. 7, and the current received first local time, the first Japan time in this example, is calculated.

More specifically, the UTC is calculated referenced to the GPS time and the current received leap seconds data, for example, and the local time is calculated by adding the local offset time to the UTC time. In this example 9 hours is added to the UTC time to get Japan time. Because daylight savings time is not used in Japan, there is no adjustment for daylight savings time. In countries such as the United States where daylight savings time is used, the corrected daylight savings time is set with extremely high precision.

The current-reception-based first local time data 52a thus calculated is then stored in the current-reception-based first local time data storage unit 52 in FIG. 7.

The current-reception-based first local time data 52a thus uses the leap seconds data that was changed by the CDMA base station 15a, but this leap seconds value is applied at the correct time so that the time information is highly precise.

If the currently received leap seconds data does not differ from the registered leap seconds data in ST21, that is, even when the leap seconds values are the same, the first local time is calculated in ST24.

Unlike when ST21 returns Yes, however, the currently received leap seconds data has not been changed by the CDMA base station 15a. In this case, therefore, the current-reception-based first local time data 52a is calculated in ST24 based on a leap seconds value that has not changed.

If ST22 returns No, that is, the UTC time data 57a is not the specified time on June 30 or December 31, the currently received leap seconds data has changed but is not the leap seconds data to be applied at the current time.

If the time is adjusted using the currently received leap seconds data in this case, the time will be slow by the amount that the leap seconds value has changed, that is, by 1 second in the above example, and the time cannot be adjusted accurately.

Therefore, if ST22 returns No, this embodiment of the invention goes to ST25. Step ST25 calculates the registered-reception-based first local time data 58a based on the registered received leap seconds data 59a in FIG. 7 instead of the currently received leap seconds data.

As a result, the leap seconds data that matches the period when it should be applied is used to produce the data for adjusting the time, and the time can be prevented from being fast or slow by one second as happens with the related art.

This embodiment of the invention thus calculates the current-reception-based first local time data or the registered-reception-based first local time data as the first Japan time, and this time is the basic time based on the GPS time and the leap seconds data that is applicable to when the time is being set.

The current-reception-based first local time data 52a that is calculated here is described next. The current-reception-based first local time data 52a is described with reference to FIG. 11.

When the wristwatch 10 receives the signal from the CDMA base station 15b in FIG. 11 and extracts the sync channel message, the received time (GPS time) is the time (the time at F in FIG. 11) four superframes (320 ms) after the end of the last superframe referenced to the time with a pilot PN offset of 0 chips (0 ms).

However, because the pilot PN offset of signals transmitted from the CDMA base station 15b in FIG. 11 is 64 chips (0.052 ms), the actual signal reception time differs by the same amount from the accurate GPS time. In other words, the actual time (EE) at the end of the last superframe transmitted from the CDMA base station 15b in FIG. 11 is the time of the GPS time acquired by the wristwatch 10 plus the pilot PN offset.

The invention therefore executes the following process. That is, the first local time data 52a in FIG. 7 is corrected as follows in ST26. The time at F in FIG. 11 is adjusted to the time at E by subtracting 320 ms (4 superframes) from the current-reception-based first local time data 52a. Because the pilot PN offset of signals from the CDMA base station 15b is 0.052 ms, this offset is then added.

The time, Japan time in this example, can therefore be generated based on the correct GPS time at the end of reception (EE) of the last superframe.

The second local time calculation program 37 in FIG. 5 does this calculation based on the current-reception-based first local time data 52a or the registered-reception-based first local time data 58a in FIG. 7 and the time difference data 44a and the pilot PN offset time data 45a in FIG. 6, and stores the result as the second local time data 53a to the second local time data storage unit 53 in FIG. 7.

An example of the time difference data 44a in FIG. 6 is the value of 320 ms (4 superframes) used above, and is stored in the time difference data storage unit 44.

An example of the pilot PN offset time data 45a is the value of 64 chips (0.052 ms) used above, and is stored in the pilot PN offset time data storage unit 45.

The GPS time acquired from the sync channel message in ST15 is an example of the future time information at a prescribed time after (such as 320 ms after) the reception time information (such as the time at E in FIG. 11), which is the time when the reception unit (such as the CDMA base station signal receiver 24) receives.

The time difference data 44a in FIG. 6 is an example of time difference information.

The first local time calculation program 36 and the second local time calculation program 37 are an example of the reception time information generating unit that generates the reception time information of the reception unit (such as the second local time data 53a) based on the future time information (such as the time at F in FIG. 11) received by the reception unit (such as the CDMA base station signal receiver 24) and the time difference information (such as the time difference data 44a).

The second local time data 53a calculated in ST26 is a highly precise time matching the GPS time, but because time is required for the calculations done in ST24 or ST25 and ST26, the time differs (is inaccurate) from the precise GPS time by an amount equal to this calculation time.

ST27 is executed to compensate for this calculation time. More specifically, a process delay time is added to the second local time data 53a in FIG. 7 to calculate the final local time. More specifically, this process delay time is equal to the time required for these calculations by the wristwatch 10, and this time is therefore determined by the wristwatch 10.

In this embodiment of the invention the process delay time data 46a is therefore stored in the process delay time data storage unit 46 as a constant value as shown in FIG. 6. The last local time calculation program 38 in FIG. 5 then adds the process delay time data 46a to the second local time data 53a in FIG. 7, and stores the result as the last local time data 54a, which is a more precise time, in the last local time data storage unit 54.

The resulting last local time data 54a is highly precise time information reflecting the GPS time and the leap seconds value.

Control then goes to ST28. In ST28 the RTC and time adjustment program 39 in FIG. 5 adjusts the RTC 25 in FIG. 4 and the hands 13 in FIG. 1 based on the last local time data 54a in FIG. 7, and completes the time adjustment.

This embodiment of the invention can more accurately adjust the time because the leap seconds data acquired from the CDMA base station 15a is used accurately according to the period when the leap seconds data should be applied.

The RTC and time adjustment program 39 is thus an example of a display time information adjustment unit that adjusts the display time information of the time information display unit (such as the RTC 25 and the hands 13). The last local time calculation program 38 is an example of an adjustment time information generating unit that generates the adjustment time information (such as the last local time data 54a) used for adjustment by the RTC and time adjustment program 39.

As described above the RTC and time adjustment program 39 is an arrangement for adjusting the RTC 25, for example, based on the leap seconds information (such as the currently received leap seconds data) and the leap seconds application time information (including leap seconds correction time data 48a).

The RTC and time adjustment program 39 is also an arrangement for adjusting the RTC 25, for example, based on the leap seconds correction time data 48a and the leap seconds data which the leap seconds comparison program 314 determines if it has changed.

This embodiment of the invention can reduce power consumption from the battery 27 because the CDMA base station signal receiver 24 stops reception of signals from the CDMA base station 15a in ST18.

This is described more specifically with reference to FIG. 11. In FIG. 11(C) denotes the power sequence of the related art when receiving the sync channel message from the CDMA base station 15b and then synchronizing the time. As shown in FIG. 11 the power remains on until FF in FIG. 11 because signals are being received.

This compares with the power sequence of this embodiment of the invention denoted by (D) in FIG. 11. As shown by (D) signal reception ends at EE in FIG. 11 and communication does not continue thereafter.

Because the wristwatch 10 according to this embodiment of the invention can reduce power consumption, the invention can be used in devices such as timepieces that require very little power while also enabling adjusting the time with extremely high precision.

Control then goes to ST29. Using the currently received local offset time data 511a stored in the currently received local offset time data storage unit 511 in ST19, the currently received local offset time data 511a and the local time difference and region correlation information table 411a stored in the local offset and region correlation information storage unit 411 in FIG. 6 are compared in ST29. More specifically, the local offset comparison program 317 in FIG. 5 compares the currently received local offset time data 511a stored in the currently received local offset time data storage unit 511 and the local offset of the local time difference and region correlation information table 411a stored in the local offset and region correlation information storage unit 411 in FIG. 6, and detects the corresponding region name information.

As described in ST8 above, the local time difference and region correlation information table 411a stores, for example, the local offset and the country or region that uses that local offset as shown in FIG. 17.

Because the local offset and the country or region that uses the local offset are stored related to each other, if the currently received local offset time data 511a is a value indicating +9 hours from UTC, the region is known to be Japan.

The local offset and region correlation information storage unit 411 is an example of a local time difference-correlated region name information storage unit, and the local time difference and region correlation information table 411a is an example of a plurality of local time difference-correlated region name information that relates time difference information for plural regions with the corresponding region name information.

The local offset comparison program 317 is an example of a location-related information adjustment unit. The local offset comparison program 317 can therefore compare the local time difference information that is contained in the time information (the currently received local offset time data 511a in this case) with the local time difference and region correlation information table 411a to quickly relate the region name corresponding to the currently received local offset time data 511a.

The region name information detected in ST29 is then assigned as the used region name data 512a in FIG. 7 in ST30. More specifically, the local offset region name extraction program 318 in FIG. 5 stores the region name information detected in ST29 to the used region name data storage unit 512 as the used region name data 512a in FIG. 7.

As described in ST10, the used region name data 512a is then indicated in ST31 from among the region name indications 100a, 100b, and 100c, for example, provided around the outside part 10b of the wristwatch 10 by, for example, driving the second hand to point to the region name indication 100a, 100b, or 100c corresponding to the used region name data 512a. More specifically, the location-related information correction program 319 in FIG. 5 moves the second hand to point to the region name indication 100a, 100b, or 100c corresponding to the used region name data 512a stored in the used region name data storage unit 512 from among the region name indications 100a, 100b, and 100c, for example, provided around the outside part 10b of the wristwatch 10.

As shown in the example in FIG. 15, the region name is extracted from the local time difference and region correlation information table 411a based on the currently received local offset time data 1la in this case. Because the data indicates +9 hours from UTC in this example, region name information indicating Japan is stored as the used region name data 512a in the used region name data storage unit 512. Then, as described above and shown in FIG. 16A, Japan (indicated as TOKYO in FIG. 15) is indicated by the second hand 13a of the hands 13 from among the region name indications 100a, 100b, and 100c on the outside part 10b of the wristwatch 10, thus indicating for the user that the region is TOKYO, that is, Japan. The second hand 13a is then held in this position for 3 seconds to inform the user.

While region name indications 100a are displayed as the location-related information on the outside part 10b in FIG. 15 as an example of the region name information, the local offset time, such as UTC0 and UTC+1, can be displayed as the local time difference information instead of such region name indications 100a, or the local offset time and the region name information can both be displayed.

Control then goes to ST32 and the currently received local offset time data 511a is stored as the previously received local offset time data 513a in the previously received local offset time data storage unit 513. The previously received local offset time data 513a stored at this time is then used from ST7 the next time the process executes.

Control then goes to ST33 to display the used region name information for three seconds, and the second hand is then returned to the original position in ST34 (FIG. 15B).

The process of ST29 to ST31 and ST33 and ST34 is the same as ST8 to ST12 described above using the previously received local offset time data 513a except that the used region name information is displayed based on the currently received local offset time data 511a in this case while the used region name information is displayed based on the previously received local offset time data 513a in the process from ST8.

The region name of the CDMA base station that is transmitting the sync channel message for time adjustment can therefore be displayed for the user because the local offset time data extracted from the received sync channel message is used to adjust the time.

Control then goes to ST35. A time adjustment interval timer operates in ST35. More specifically, the start time adjustment decision program 311 in FIG. 5 operates and references the time adjustment interval data 47a in FIG. 6. This time adjustment interval data 47a is 24 hours in this embodiment. The time adjustment interval data 47a is stored in the time adjustment interval data storage unit 47.

As a result, the next time adjustment process starts in ST36 24 hours after the previous time adjustment, and the process repeats from ST1.

FIG. 8 to FIG. 10 describe a process whereby the local offset time and the daylight savings time data in FIG. 12 are automatically adjusted based on the sync channel message received from the CDMA base station 15a, but this data can alternatively be set by the user of the wristwatch 10.

In this case the local offset time that is input using the crown 28 in FIG. 1, for example, is stored as the input local offset time data 55a in FIG. 7 to the input local offset time data storage unit 55. The similarly input daylight savings time data is stored as the input daylight savings time data 56a in the input daylight savings time data storage unit 56.

The current-reception-based first local time data 52a, for example, is calculated based on this input data in ST24 or ST25 described above, and the time can therefore be adjusted as desired by the user.

This embodiment is described using by way of example adding “1 second” as the leap seconds in the CDMA base station 15a, but the invention is not so limited and includes arrangements in which “1 second” is subtracted.

Furthermore, Walsh code (32) is generated by the frequency division counter 17c for example, in the above embodiment, but the invention is not so limited. Alternatively, a code signal for the Walsh code (32) shown in FIG. 13B and FIG. 14 can be stored in FIG. 6 and mixed with the sync channel signal by the baseband unit in FIG. 3.

This arrangement enables reducing the circuit size even more, and reduces the power consumption.

The storage unit for the Walsh code (32) in this variation is a time information extraction signal storage unit.

The used region name data 512a is indicated by the second hand as shown in FIG. 15 in this embodiment of the invention, but the used region name information and local offset time data can be displayed as the location-related information in a display 14 on the wristwatch 10 as shown in FIG. 16A. In this example LONDON is displayed as the used region name information and UTC0 is displayed as the local offset time.

In this case the location-related information can be displayed based on the previously received local offset time data if the pilot channel signal cannot be synchronized in ST4 and all of the service area tables are referenced in ST5, and the location-related information can be displayed based on the currently received local offset time data once reception of the sync channel message is completed after synchronizing with the pilot channel signal in ST4.

After displaying the location for three seconds, the display 14 can be turned off to reduce power consumption as shown in FIG. 16B. The location-related information can also be displayed again on the display 14 when instructed by the user.

The used region name information and local offset time data, or either the used region name information or the local offset time data, can thus be displayed as the location-related information in the display 14.

The location-related information can also be input using the crown 28 or other external input unit.

The invention is not limited to the foregoing embodiment. Whether to apply the leap seconds value is determined above referenced to 23:59:59 on June 30 or December 31, but the invention is not so limited and a reference time of 00:00:00 on July 1 or January 1, or 00:00:30 on July 1 or January 1, can be used.

This arrangement is effective when the CDMA base station 15a inserts (changes) the leap seconds value at 23:59:59 on June 30 or December 31 or later.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A time adjustment device comprising:
a reception unit that receives a prescribed signal containing time information transmitted by a base station;
a displayed time information adjustment unit that adjusts an information display unit for displaying the time based on the time information contained in the prescribed signal; and
a location-related information adjustment unit that adjusts a location-related information display unit that displays location-related information for the base station based on the time information contained in the prescribed signal.

2. The time adjustment device described in claim 1, further comprising:
a local time difference information storage unit that stores local time difference information that is contained in the time information and denotes the time difference between the location of the base station and the Universal Time Code;
wherein the local time difference information is displayed on the location-related information display unit.

3. The time adjustment device described in claim 2, further comprising:
a local time-difference-correlated region name information storage unit that stores local time-difference-correlated region name information relating the local time difference information with corresponding region name information;
wherein the local time-difference-correlated region name information related to the local time difference information is displayed on the location-related information display unit.

4. The time adjustment device described in claim 3, wherein:
the local time-difference-correlated region name information storage unit stores a plurality of local time-difference-correlated region name information relating time difference information for plural regions with the corresponding region name information.

5. The time adjustment device described in claim 1, further comprising:
a local time difference information confirmation unit that confirms if the local time difference information is in the local time difference information storage unit;
wherein the location-related information display unit displays based on the local time difference information confirmed by the local time difference information confirmation unit.

6. The time adjustment device described in claim 1, wherein:
the location-related information in the location-related information display unit can be input by means of an external input unit that can be operated by the user.

7. The time adjustment device described in claim 3, wherein the region name information is country-of-use information or city-of-use information.

8. A timepiece device having a time adjustment device, comprising:
a reception unit that receives a prescribed signal containing time information transmitted by a base station;
a displayed time information adjustment unit that adjusts an information display unit for displaying the time based on the time information contained in the prescribed signal; and
a location information adjustment unit that adjusts a location information display unit that displays location information for the base station based on the time information contained in the prescribed signal.

9. A time adjustment method for a time adjustment device, comprising:
a reception unit that receives a prescribed signal containing time information transmitted by a base station;
an information display unit that display time; and
a location information display unit that displays location information for the base station;
wherein the information display unit is adjusted based on the time information contained in the prescribed signal; and
the location information display unit is adjusted based on the time information contained in the prescribed signal.
